(19) United States
(12) Patent Application Publication
(10) Pub. No.: US 2018/0308121 A1
(43) Pub. Date: Oct. 25, 2018

(54) DATA PROCESSING METHOD, SERVER, USER TERMINAL AND STORAGE MEDIUM

(71) Applicant: TENCENT TECHNOLOGY (SHENZHEN) COMPANY LIMITED, Shenzhen City, Guangdong (CN)

(72) Inventor: Ming JIANG, Shenzhen (CN)

(73) Assignee: TENCENT TECHNOLOGY (SHENZHEN) COMPANY LIMITED, Shenzhen City, Guangdong (CN)

(21) Appl. No.: 15/769,151

(22) PCT Filed: May 27, 2017
(86) PCT No.: PCT/CN2017/086307

§ 371 Date: Apr. 18, 2018

(30) Foreign Application Priority Data
Jun. 2, 2016 (CN) 201610389777.0

(51) Int. Cl. G06Q 30/02

(52) U.S. Cl. CPC G06Q 30/0242; G06Q 30/0234; G06Q 30/0257

(57) ABSTRACT

A data processing method and server are provided. The method includes generating first promotion data including a feedback rule, and sending the first promotion data to a first user. In response to a confirmation message, a user identifier of the first user is added, as a home identifier, to the first promotion data, to obtain second promotion data, and the second promotion data is sent to the first user. In response to a resource transfer request from a second user, third promotion data is searched for that includes the home identifier and the feedback rule, and a number of transferred resources of the second user is reduced according to the third promotion data. The home identifier and the feedback rule are extracted from the third promotion data, and promotion feedback information corresponding to the home identifier is determined according to the feedback rule and data application information.

### CROSS-REFERENCE TO RELATED APPLICATIONS

This application is a National Stage entry of International Patent Application No. PCT/CN2017/086307, filed on May 27, 2017, which claims priority from Chinese Patent Application No. 201610389777.0, entitled “DATA PROCESSING METHOD, SERVER, AND USER TERMINAL” filed in the Chinese Patent Office on Jun. 2, 2016, the disclosures of which are incorporated by reference herein in their entirety.

### BACKGROUND

### Field

This application relates to the Internet technologies, and in particular, to a data processing method, a server, and a user terminal.

### Description of Related Art

A large number of data sharing behaviors exist in a network. For example, a user shares interesting articles read by the user with a circle of friends of WeChat, or group-sends a link to contacts of the user by using an email. In a process of using the network, each user accumulates, on the network, a social relationship chain of a particular number of relationships. For example, a circle of friends of WeChat, people followed on microblog, email contacts, and the like may all be considered as a social relationship chain.

On the other hand, a large number of data promotion requirements also exist in the network. For example, a merchant hopes that merchant information of the merchant is greatly propagated and promoted in the network, thereby improving the notability of the merchant and increasing profits. Data that needs to be promoted in the network may be denoted as promotion data.

### SUMMARY

It is an aspect to provide a data processing method, a server, and a user terminal, to improve the frequency of propagation of promotion data in a network.

According to an aspect of one or more example embodiments, there is provided a method. The method includes generating first promotion data including a feedback rule, and sending the first promotion data to a first user. In response to a confirmation message, a user identifier of the first user is added, as a home identifier, to the first promotion data, to obtain second promotion data, and the second promotion data is sent to the first user. In response to a resource transfer request from a second user, third promotion data is searched for that includes the home identifier and the feedback rule, and a number of transferred resources of the second user is reduced according to the third promotion data. The home identifier and the feedback rule are extracted from the third promotion data, and promotion feedback information corresponding to the home identifier is determined according to the feedback rule and data application information.

According to other aspects of one or more example embodiments, there is provided a server, a user terminal and a computer readable medium related to the method.

### BRIEF DESCRIPTION OF THE DRAWINGS

Example embodiments will be described below with reference to the accompanying drawings, in which:

FIG. 1 is a schematic flowchart of a data processing method 100 according to an example embodiment of this application;

FIG. 2 is an interactive schematic diagram of a method 200 for pushing promotion data according to an example embodiment of this application;

FIG. 3 is an interactive schematic diagram of a method 300 for sharing promotion data according to an example embodiment of this application;

FIG. 4A to FIG. 4D are schematic diagrams of scenarios of performing coupon promotion by using a circle of friends of WeChat;

FIG. 5 is an interactive schematic diagram of a method 500 for using promotion data according to an example embodiment of this application;

FIG. 6 is a schematic flowchart of a data processing method 600 according to an example embodiment of this application;

FIG. 7 is an interactive schematic diagram of a data processing method 700 according to an example embodiment of this application;

FIG. 8 is a schematic structural diagram of a data promotion server 800 according to an example embodiment of this application;

FIG. 9 is a schematic structural diagram of a WeChat server 900 according to an example embodiment of this application;

FIG. 10 is a schematic structural diagram of a user terminal 1000 according to an example embodiment of this application; and

FIG. 11 is a schematic diagram of composition of a communications system 1100 according to an example embodiment of this application.

### DETAILED DESCRIPTION

To make the objectives, technical solutions, and advantages of this application clearer and more comprehensible, the following further describes this application in detail with reference to the accompanying drawings and examples.

An example embodiment of this application provides a solution. In a process of propagating promotion data, the promotion data is associated with a user identifier of a promotion user propagating the promotion user, and/or in a process of using the promotion data, data mining and tracking are performed by identifying the user identifier to obtain data application information, and promotion feedback information is provided to the promotion user based on the data application information, and registered users in a network are encouraged, by using the promotion feedback information, to strengthen the efforts to propagate the promotion data. The data application information may be a degree to which the promotion data is used, for measuring an effect of promoting application. The promotion feedback information may be the number of returned resources that is provided by a merchant and associated with the data application information. As may be seen, according to example embodiments of this application, a data promotion requirement is better connected to a data sharing behavior to form a closed feedback mechanism, so as to sufficiently excite a network user to perform data promotion by using a social relationship chain, thereby improving the frequency of propagation of promotion data in a network.

It should be noted herein that in this application, a promotion user may also be referred to as a first user, and a developed user may also be referred to as a second user. The promotion user is a user selected by a data promotion server. The data promotion server may send promotion data (such as a coupon of a merchant) to the promotion user, and may generate a piece of dedicated promotion data (including an identifier of the promotion user) for the promotion user. Such dedicated promotion data may be a personal coupon, with information about the promotion user, of a merchant. The promotion user may share the dedicated promotion data thereof to another user (such as a friend in a social application thereof), and the another user may be referred to as a developed user. The developed user may consume at a corresponding merchant by using the dedicated promotion data shared by the promotion user, such as by using a personal coupon of the promotion user.

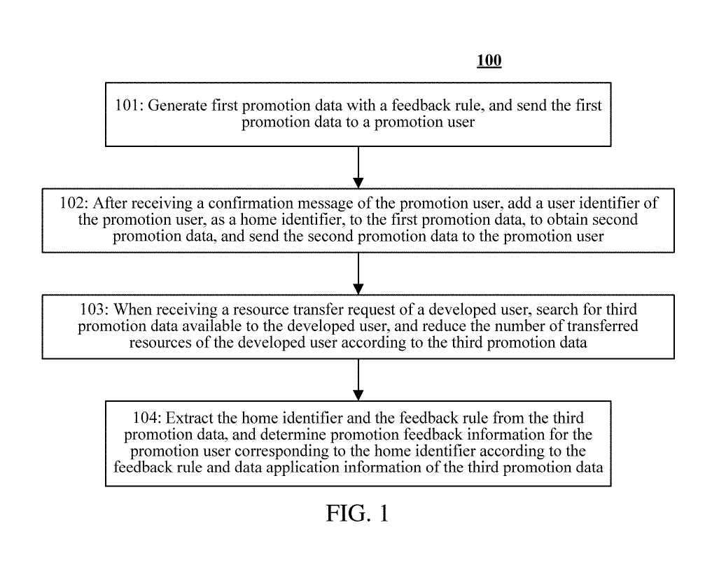

FIG. 1 is a schematic flowchart of a data processing method 100 according to an example embodiment of this application. In an example, the method may be applied to a data promotion server. The method 100 includes the following operations.

In step 101: first promotion data with a feedback rule is generated, and the first promotion data is sent to a promotion user. The feedback rule is used to indicate a correspondence between the promotion feedback information and the data application information.

In step 102, after a confirmation message of the promotion user is received, a user identifier of the promotion user is added as a home identifier to the first promotion data, to obtain second promotion data, and the second promotion data is sent to the promotion user.

In an example, the first promotion data and the second promotion data may both be stored in the data promotion server in a form of a data record. A data record of this type is referred to as a “promotion data record” below.

In step 103, when a resource transfer request for a developed user is received, third promotion data available to the developed user is searched for, and the number of transferred resources of the developed user is reduced according to the third promotion data. In an example, the resource transfer request is a consumption payment request.

In step 104, the home identifier and the feedback rule are extracted from the third promotion data, and the promotion feedback information is determined for the promotion user corresponding to the home identifier according to the feedback rule and data application information of the third promotion data.

In an example, the method 100 may be implemented by the data promotion server deployed on a network. In an example, the data promotion server may be a platform having a registered user management capability and a network payment settlement capability, such as a WeChat server.

Assuming that the data promotion server selects a user A as a promotion user, and pushes a merchant coupon of a merchant 1 to the user A, after the user A confirms receiving the merchant coupon, the data promotion server generates a dedicated personal coupon for the user A based on the merchant coupon, and sends a coupon ID of the personal coupon to the user A for storage. It should be noted that during actual implementation, each coupon (either a merchant coupon or a personal coupon) issued by the data promotion server may be uniquely identified by using a coupon ID, and coupon IDs of different coupons are different. The uniqueness of the personal coupon is reflected in that a user identifier of the user A is recorded in the personal coupon. The user A may share the personal coupon on a network, so that other users may also enjoy benefits brought by the coupon. Assuming that a user B sees and receives the personal coupon on the network, the personal coupon is stored in a coupon list of the user B. After that, when the user B consumes at the merchant 1, the data promotion server may learn that the user B has a coupon related to the merchant 1, and deducts a particular payment amount by using the coupon. Because the coupon is a personal coupon, the data promotion server further calculates a rebate amount for the user A as a reward for sharing the personal coupon on the network by the user A.

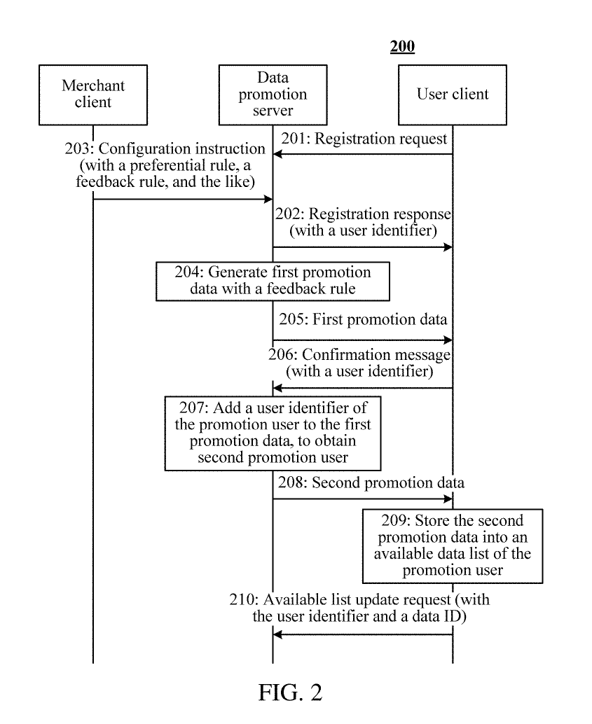

FIG. 2 is a schematic flowchart of a method 200 for pushing promotion data according to an example embodiment of this application. In an example, the method 200 includes the following operations.

In step 201, a data promotion server receives a registration request of a user client, and generates a corresponding user identifier for the registration request.

In an example, the user client is a client used by a user, and may be a user application (APP) installed on an electronic device such as a mobile phone, a tablet computer, a general-purpose computer, an intelligent wearable device, a smart TV, or a camera. In an example, the user may register on the data promotion server by using the user client, or logs in to the data promotion server for performing operations such as personal account management, social relationship maintenance, and network consumption payment. In an example, the data promotion server may record and maintain a large number of registered users. The data promotion server sets a personal account for each registered user, and records information items such as a user identifier, a social relationship chain, and a fund balance of the registered user.

In step 202, the data promotion server records the user identifier of a registered user, and notifies the registered user of the user identifier by using a registration response.

In step 203, the data promotion server receives a configuration instruction of a merchant client. In an example, the configuration instruction is used to configure a preferential rule, a feedback rule, and the like.

It should be noted that user client and the merchant client are clients of two different types, and have different operation rights in the data promotion server. The user client is used to generate and manage a personal account. The merchant client is aimed at a merchant customer, and is used to apply for an official account[SY1] and maintain the official account.

In an example, the preferential rule is used to indicate the number of transferred resources that may be reduced in resource transfer. In an example, the preferential rule defines a payment amount that may be reduced during consumption payment by a network user receiving a merchant coupon. The payment amount that may be reduced may be an absolute amount (such as deduction of 5 Yuan), or a reduction proportion of a payment amount (such as 20% off the payment amount). In an example, the preferential rule further includes: a use constraint condition, used to constrain use scenarios of the merchant coupon, such as a use time limit, or an amount threshold. In an example, the use constraint condition may be used to set a time point at which the merchant coupon starts to take effect, a time period in which the merchant coupon takes effect, or a time point at which the merchant coupon fails (that is, a deadline). In an example, the use constraint condition may be used to set that the merchant coupon takes effect only when a payment amount exceeds a particular amount threshold. That is, the merchant coupon may be used only when the payment account reaches a particular value. For example, a coupon may specify that it may be used only when a consumption amount reaches 100 Yuan. The 100 Yuan is an amount threshold set in the constraint condition of the coupon.

In an example, the preferential rule may be made into a form of a data template, for sharing by promotion data records stored on the data promotion server. Correspondingly, each promotion data record may cite the preferential rule by recording a serial number of the preferential rule, and does not need to record all content of the preferential rule, thereby reducing a data storage amount. Similarly, the feedback rule may also be made into a form of a data template, and is cited by using a serial number of the feedback rule.

In step 204, the data promotion server generates first promotion data with a feedback rule.

In an example, the merchant client sets the first promotion data in the data promotion server, for promoting an official account, and the like of the merchant client, and enhancing the influence and the attraction of the merchant client. In an example, the first promotion data includes information items such as a data ID, an issue ID, a preferential rule, and a feedback rule. The data ID is used to uniquely identify the first promotion data. The issue ID is used to indicate a merchant issuing the first promotion data (that is, the merchant identifier). The preferential rule is used to indicate a payment amount that may be deducted by the first promotion data in use. The feedback rule is used to indicate a correspondence between promotion feedback information and data application information. The data application information is a degree to which the first promotion data is propagated or used, and the promotion feedback information is a reward and the like to the promotion user propagating the first promotion data.

In an example, the first promotion data may be a merchant coupon. In an example, the data promotion server establishes a coupon record according to an instruction of the merchant client, for storing information items of the merchant coupon. In an example, the merchant coupon is an electronic coupon, and may be used in network payment.

In step 205, the data promotion server selects a promotion user from the registered users, and sends the first promotion data to the promotion user.

In step 206, the data promotion server receives a confirmation message of the promotion user.

In step 207, the data promotion server adds a user identifier of the promotion user to the first promotion data, to obtain second promotion data.

In an example, the first promotion data is promotion data set by the merchant client for a plurality of promotion users, and the second promotion data is promotion data exclusive to a particular promotion user. In an example, the second promotion data includes information items such as a data ID, an issue ID (which may be a merchant identifier), a home ID (which may be the user identifier of the promotion user), a preferential rule, and a rebate rule. The home ID is used to indicate a promotion user to which the second promotion data belongs, so that the data promotion server may identify a promotion user propagating the second promotion data. In an example, the data ID is a series of numbers that are generated by the data promotion server when the data promotion server creates each promotion data record and that are used for identifying the promotion data record. Either the first promotion data or the second promotion data has a data ID thereof as a unique identification code.

Further, the second promotion data includes an information item: a data attribute. The data attribute may have two values: use or spread. If the data attribute is spread, a promotion user may propagate the received second promotion data. If the data attribute is use, the promotion user may use the second promotion user, for example, enjoy an amount discount in consumption payment according to the preferential rule recorded in the second promotion data, but cannot further propagate the second promotion data. In an example, the second promotion data may be a personal coupon. In an example, the personal coupon is an electronic coupon, and may be used in network payment.

In step 208, the data promotion server sends the second promotion data to the promotion user.

In an example, the data promotion server may send some or all of the information items of the second promotion data to the promotion user. In an example, the data promotion server may send the data ID of the second promotion data to the promotion user, and may further send the data attribute of the second promotion data to the promotion user for storage.

In step 209, the promotion user stores the second promotion data into an available data list of the promotion user. In an example, if the data promotion server sends the data ID of the second promotion data, the promotion user also stores the data ID into the available data list.

In an example, the available data list is used to store promotion data that may be used by a particular registered user, and usually records a data ID of the promotion data. The registered user may perform consumption payment by using the promotion data in the available data list of the registered user, or may share the promotion data on a network.

In step 210, the promotion user sends an available list update request to the data promotion server, the available list update request including the user identifier of the promotion user and a data ID of the second promotion data, for updating the available data list stored by the data promotion server for the promotion user.

It should be noted that the data promotion server and the promotion user may synchronously maintain the available data list. That is, the available data list is stored on both the data promotion server and the promotion user, and the user identifier of the promotion user is used as a data index.

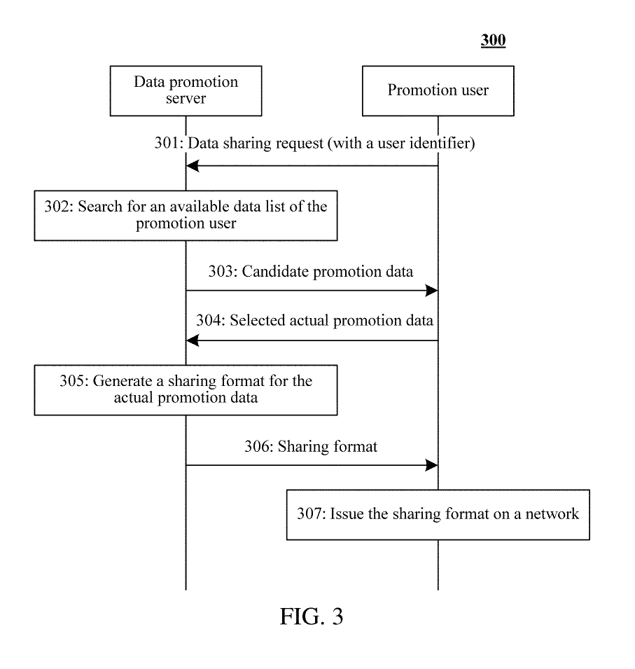

FIG. 3 is a schematic flowchart of a method 300 for sharing promotion data according to an example embodiment of this application. In an example, the method 300 includes the following operations. In an example, the operations of a promotion user are implemented by a user client.

In step 301, a promotion user sends a data sharing request to a data promotion server, the data sharing request including a user identifier of the promotion user. In an example, the data sharing request may be implemented by clicking a button “promote” or “share” on a display interface of the user client by the promotion user.

In steps 302 to 303, the data promotion server searches for an available data list of the promotion user according to the user identifier, and sends candidate promotion data whose data attribute is “spread” to the promotion user for selection.

In an example, the candidate promotion data is a promotion data record whose data attribute is “spread” in the available data list of the promotion user. Assuming that the user identifier of the promotion user is U1, and the available data list thereof is shown in Table 1, after finding Table 1, the data promotion server sends three data IDs: D1, D2, and D4 to the promotion user U1, indicating that the promotion user U1 currently has 3 pieces of candidate promotion data that may be propagated in a network. For promotion data D3, the data attribute thereof is “use”, and therefore the promotion data D3 does not appear in a candidate list for sharing by the promotion user.

TABLE 1

| User identifier | Data ID | Data attribute |
|---|---|---|
| U1 | D1 | Spread |
| | D2 | Spread |
| | D3 | Use |
| | D4 | Spread |

In step 304, the data promotion server receives actual promotion data selected by the promotion user.

In an example, the candidate promotion data may be displayed on the user client of the promotion user, for selection by the promotion user. When the promotion user selects the actual promotion data by means of clicking, a data ID of the actual promotion data is sent to the data promotion server from the user client. For example, actual promotion data whose data ID is D2 may be selected.

In steps 305 to 306, the data promotion server generates a sharing format for the actual promotion data, and provides the sharing format to the promotion user.

In an example, the data promotion server finds, according to the data ID, the actual promotion data stored by the data promotion server, converts some or all of information items of the actual promotion data into a sharing format in a form such as a network link form or a graphic code (such as a bar code or a two-dimensional code), and sends the sharing format to the promotion user.

In an example, the network link corresponds to a group of computer executable operations (such as instruction codes). After the network link is clicked, the group of computer executable operations will be triggered to be executed. In an example, the group of computer executable operations include: identifying a data ID in the network link, and storing the data ID into an available data list of a user client clicking the network link.

In an example, the graphic code is: a bar code that records data symbol information by using a graphics having a particular geometric shape and distributed according to a particular law. Specifically, the graphic code may be a one-dimensional code, a two-dimensional code, another graphic code, or the like, and in particular, two-dimensional codes store relatively much information. In an example, the two-dimensional code is a bar code that has readability and that is formed by expanding another dimension based on the one-dimensional code. The two-dimensional code represents binary data by using a black and white rectangular pattern. After scanning the two-dimensional code, a reading device may obtain information included in the two-dimensional code. The width of the one-dimensional code records information, but the length thereof does not record information. Both the length and the width of the two-dimensional code record information. Compared with the one-dimensional code, the two-dimensional code is provided with a “positioning point” and a “fault tolerance mechanism”. The fault tolerance mechanism enables information on the bar code to be correctly restored when the bar code is polluted and damaged, or the bar code is not completely identified.

In step 307, the promotion user issues the sharing format of the actual promotion data into a network.

In an example, the user client of the promotion user may propagate the second promotion data to other users in a social relationship chain by using the social relationship chain thereof. In an example, the social relationship chain may alternatively be referred to as a user relationship chain, and is a relationship chain formed by the promotion user indicated by the user identifier and other users in a network. In an example, the social relationship chain may be mapping of offline social relationships online, or may be relationships formed by interaction between users in online social scenarios, such as microblog friends.

In an example, the user client may link the second promotion data into a microblog for transmission. For example, the second promotion data is embedded, in a form of a two-dimensional code, into a microblog sent by the user client. Other users reading the microblog may store the second promotion data into user clients thereof, for example, into a picture folder. In an example, the user client may issue the second promotion data into a QQ space for obtaining by other users. In an example, the user client may issue the second promotion data when making comments on a consumption platform such as Dianping or Ctrip. In an example, the user client may propagate the second promotion data in a network by means of an email or a bulletin board system (BBS).

When the data promotion server is a WeChat server, the user client may send the sharing format of the second promotion data to a WeChat group (such as a group chat) for clicking and obtaining by other members in the WeChat group, exclusively send the sharing format to a particular WeChat friend (such as a private chat), or issue the sharing format to a circle of friends of WeChat. In an example, the promotion user may issue the sharing format to a network by other means after obtaining the sharing format. For example, the promotion user locally downloads the graphic code to an electronic device on which the user client is installed, and then propagates the graphic code by means of an email, a blog, or a microblog.

That is, the second promotion data may be pushed on any social occasion of the registered user on the network. It should be noted that the user client may automatically push the second promotion data. For example, in a period of time, the second promotion data is embedded into each microblog issued by the registered user. In an example, the user client may manually push the second promotion data. For example, a registered user manually clicks a button “promote” to forward the second promotion data into a WeChat group.

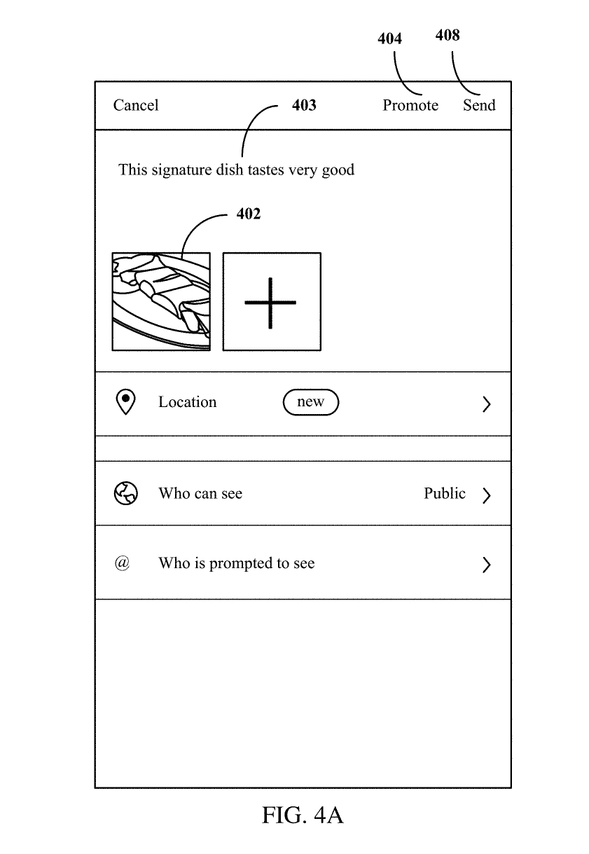

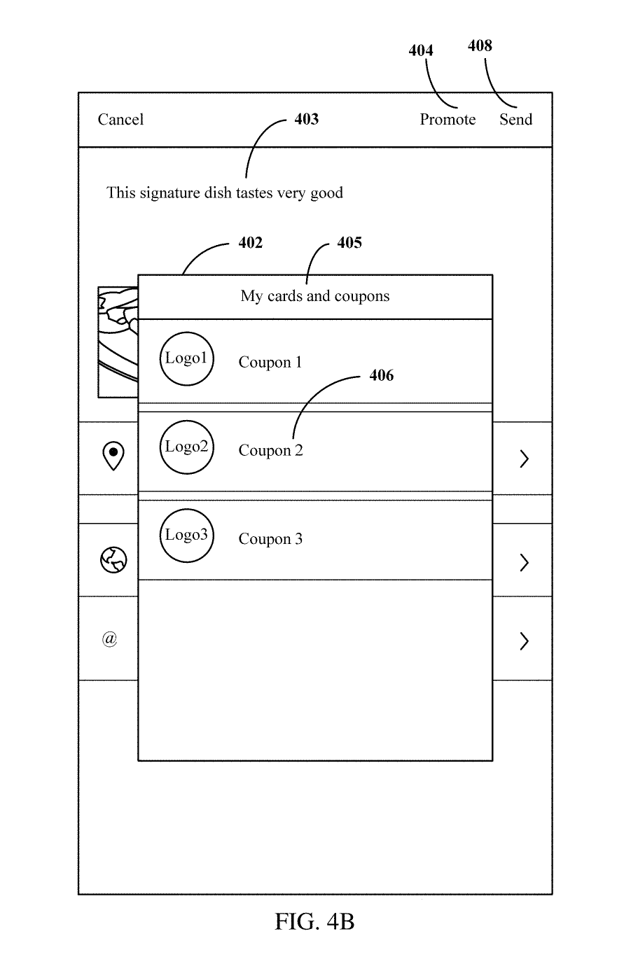

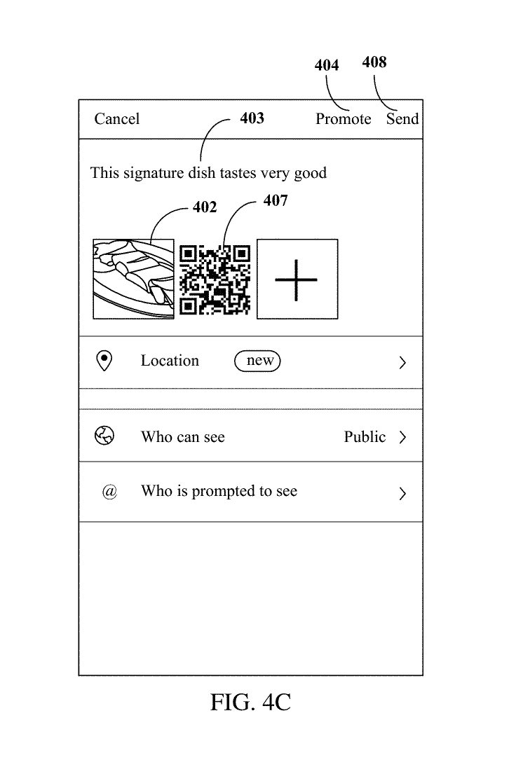

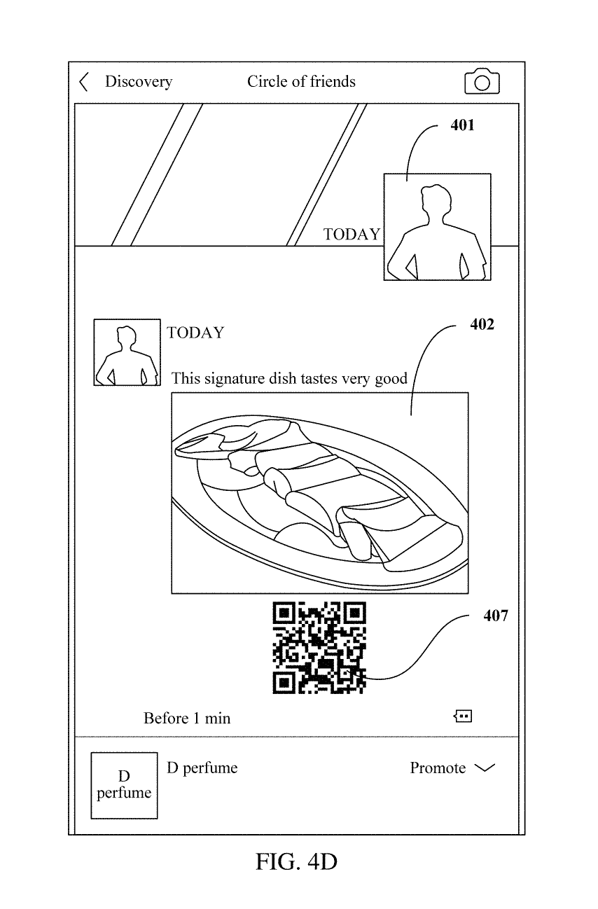

In an example, when a user photographs delicious food or other content and shares the photos by using a social relationship chain of the user after contacting an offline merchant (such as consuming at the merchant, or taking a brochure of the merchant without consumption), the user issues the photos to a circle of friends with a two-dimensional code having merchant information, preferential information, and personal information. FIG. 4A to FIG. 4D are schematic diagrams of scenarios of performing coupon sharing [SY2]by using a circle of friends of WeChat. Specifically, after dining at a restaurant, a promotion user 401 (whose WeChat name is TODAY) photographs a dish to obtain a photo 402. In FIG. 4A, the promotion user 401 opens a circle of friends of WeChat, selects an option “select from a mobile phone album”, adds the photo 402 to an editing interface “WeChat discovery”, and makes a comment 403 “this signature dish tastes very good”. When the promotion user 401 clicks a button 404 “promote”, the interface jumps to FIG. 4B. A submenu 405 “my cards and coupons” appears in FIG. 4B for selection by the promotion user 401. It should be noted that the submenu 405 “my cards and coupons” is a candidate list for sharing promotion data by the promotion user 401. When the promotion user 401 selects a coupon 2 406, as shown in FIG. 4C, a two-dimensional code 407 of the coupon 2 406 is added to the WeChat discovery. After the promotion user 401 clicks a button 408 “send”, the WeChat discovery is issued to the circle of friends of WeChat, as shown in FIG. 4D. Certainly, the scenario shown in FIG. 4 may alternatively occur in other consumption and entertainment places such as a cinema. The two-dimensional code 407 may alternatively be replaced with another sharing format such as a bar code or a network link.

In an example, the button 404 “promote” may not be additionally disposed, and a function of popping up the submenu 405 “my cards and coupons” is integrated onto the button 408 “send”. That is, after the promotion user 401 adds the photo 402 and the comment 403 to the editing interface “WeChat discovery”, the submenu 405 “my cards and coupons” will pop up the first time the promotion user 401 clicks the button 408 “send”. After the promotion user 401 selects a coupon (such as a coupon 2 406) from the candidate list, an interface shown in FIG. 4C appears. In this case, the promotion user 401 clicks the button 408 “send” for the second time, and the WeChat discovery is issued to the circle of friends of WeChat, as shown in FIG. 4D.

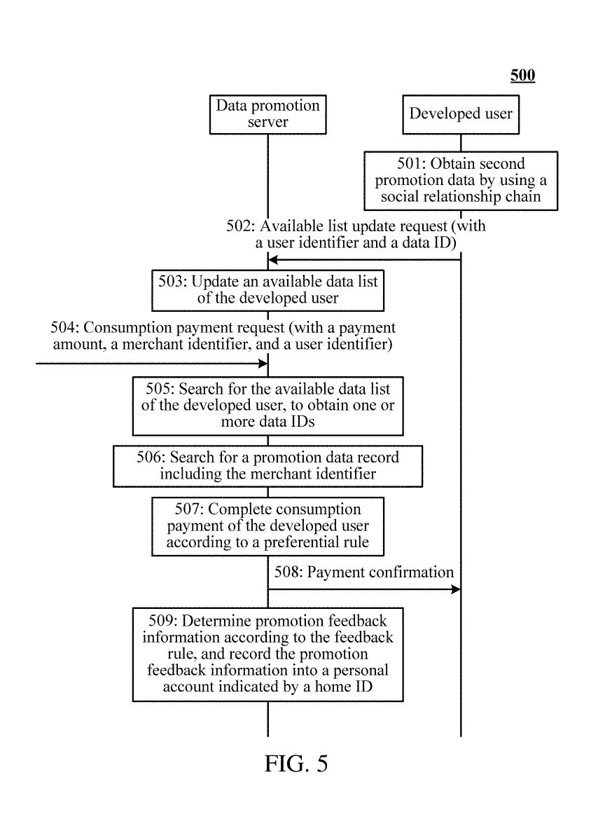

FIG. 5 is an interactive schematic diagram of a method 500 for using promotion data according to an example embodiment of this application. In an example, the method 500 includes the following operations.

In step 501, a developed user obtains second promotion data by using a social relationship chain, and stores the second promotion data into an available data list of the developed user.

In an example, the developed user is a registered user of a data promotion server, or another network user. For example, when seeing the WeChat discovery in FIG. 4D, a WeChat friend in the circle of friends of WeChat of the promotion user 401 in FIG. 4 may obtain a personal coupon corresponding to the two-dimensional code 407 by identifying the two-dimensional code 407 synchronously appearing with the photo 402, so as to obtain merchant information, preferential information, and the like. In an example, after the WeChat friend (which may be considered as the developed user in step 501) clicks to receive the personal coupon, the personal coupon is stored in a coupon list of the WeChat friend for use by the WeChat friend in subsequent consumption.

In an example, if second promotion data on the network uses the sharing format: a graphic code, the developed user may store a data ID of the second promotion data recorded in the graphic code into the available data list by clicking the graphic code. In this case, a local available data list of the developed user will be updated, and an available data list maintained in the data promotion server for the developed user will also be updated.

In step 502, the developed user sends an available list update request to the data promotion server, the available list update request including a user identifier of the developed user and a data ID of the second promotion data. In an example, after the developed user clicks the graphic code, a user client used by the developed user sends the available list update request to the data promotion server.

In step 503, the data promotion server updates an available data list, stored in the data promotion server, of the developed user. In an example, the data promotion server finds the corresponding available data list according to the user identifier, and adds the data ID of the second promotion data to the available data list.

Assuming that the second promotion data is D2 in Table 1, before being updated, the available data list of a developed user U2 is shown in Table 2, and after being updated, the available data list of the developed user U2 is shown in Table 3.

TABLE 2

| User identifier | Data ID | Data attribute |
|---|---|---|
| U2 | D5 | Spread |
| | D6 | Spread |
| | D7 | Use |

TABLE 3

| User identifier | Data ID | Data attribute |
|---|---|---|
| U2 | D5 | Spread |
| | D6 | Spread |
| | D7 | Use |
| | D2 | Spread |

For the sharing format: a network link, operations of the developer user are also similar to those for the graphic code. Details are not described herein again.

In step 504, the data promotion server receives a consumption payment request, the consumption payment request including a payment amount, a merchant identifier, and the user identifier of the developed user.

In step 505, the data promotion server searches for the available data list of the developed user according to the user identifier, to obtain one or more data IDs recorded in the available data list.

In step 506, the data promotion server searches, one by one, for promotion data records corresponding to the one or more data IDs, and finds a promotion data record including the merchant identifier.

In step 507, the data promotion server deducts a discount amount from the payment amount according to a preferential rule recorded in the promotion data record, to complete consumption payment of the developed user.

In step 508, the data promotion server determines corresponding promotion feedback information from data application information according to a feedback rule recorded in the promotion data record, and records the promotion feedback information into a personal account indicated by a home ID in the promotion data record for use by consumption payment of the registered user.

In an example, after the promotion data record is positioned, the data promotion server identifies a registered user propagating the promotion data record found in step 506, so as to record and feed back a propagation behavior of the registered user.

In an example, the data application information includes: a payment amount associated with the promotion data record, and/or, a corresponding number of use times of the home identifier in the promotion data record. Correspondingly, the data promotion server may record the payment amount corresponding to the promotion data record into an application effect item of the personal account. For another example, upon reception of the second promotion data corresponding to the home identifier each time, the data promotion server adds 1 to the number of use times on the application effect item of the personal account. By collecting the data application information, the data promotion server may intuitively obtain a promotion effect of the registered user, so as to provide the promotion feedback information to the registered user as encouragement.

In an example, the promotion feedback information is a fund rebate, a WeChat red envelope, another coupon, or the like. In an example, the promotion feedback information may be a fund balance item added to the personal account. In an example, the data promotion server may convert the data application information into the promotion feedback information at a preset time node, rather than perform fund rebating in real time. For example, a rebate amount is calculated once per month, and is added to the fund balance item.

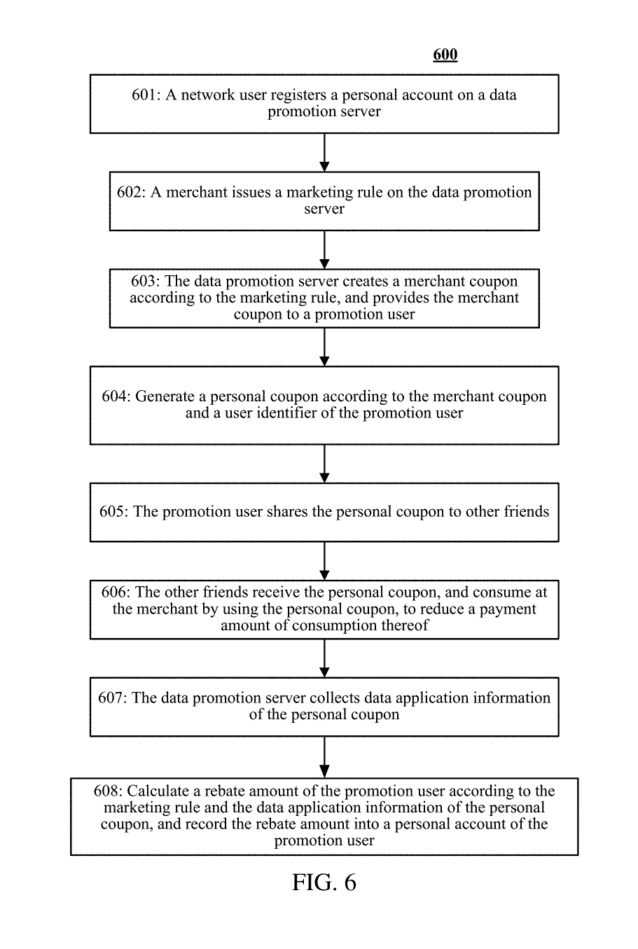

FIG. 6 is a schematic flowchart of a data processing method 600 according to an example embodiment of this application. In an example, the method 600 includes the following operations.

In step 601, a network user registers a personal account on a data promotion server to become a registered user.

In an example, the data promotion server is a network control platform for information promotion. In an example, the personal account includes: a user identifier, for identifying the registered user on the data promotion server. In an example, the registered user may register the personal account in a plurality of manners. For example, the registered user downloads a user client corresponding to the data promotion server, and logs in to the data promotion server by using the user client for registration. For another example, the registered user accesses a web page presented by the data promotion server, completes registration of the personal account by using a registration option set on the web page, and obtains the personal account. In an example, the user client may be installed on a hardware device such as a mobile terminal (for example, a smartphone or a tablet computer), a general-purpose computer, or another electronic device (for example, a smart TV). In an example, the user client is a marketing promotion application (APP).

In step 602, a merchant issues a marketing rule on the data promotion server.

In an example, the merchant may configure the marketing rule by using a merchant client. In an example, the merchant client may be installed on a hardware device such as a mobile terminal (for example, a smartphone or a tablet computer), a general-purpose computer, or another electronic device (for example, a smart TV). In an example, the merchant client and the user client have different rights. For example, the two clients have different interfaces for interaction with the data promotion server. In an example, the user client may be used to manage the personal account of the registered user for the registered user. The merchant client may be used to set a marketing rule, and this cannot be implemented by the user client.

In an example, the marketing rule is a rule related to promoting and selling products (such as commodities or services). In an example, the marketing rule includes: a preferential rule, a propagation rule, a rebate rule, and the like.

In an example, the preferential rule is used to indicate content such as how to configure an electronic coupon. In an example, the electronic coupon is one or more data marks bestowed by a merchant to a user in a scenario of Internet payment. The user may reduce a payment amount by using these data marks. In an example, the Internet payment may include a plurality of manners such as online banking, third-party payment, and mobile payment.

In an example, the merchant may apply for an official account to the data promotion server, and implement communication and interaction of media files such as text, pictures, voices, and videos with specific groups by using the official account. Different from the personal account, the official account cannot actively add a friend, but may be found on the network, so as to be added by other people as a friend. After following the official account, the registered user of the data promotion server becomes a user followed by the official account. The official account may provide various services, such as message group transmission, message private transmission, and user message processing, to the user followed by the official account. In an example, after application for the official account succeeds, a two-dimensional code, name card recommendation, and the like may be generated by using the data promotion server, so that the registered user follows the official account.

In step 603, the data promotion server creates a merchant coupon according to a preferential rule in the marketing rule, and provides the merchant coupon to a promotion user.

In an example, the data promotion server creates the merchant coupon for a merchant according to a preferential rule configured by the merchant, and records information items of the merchant coupon in a form of a coupon record.

In an example, the promotion user may be any registered user of the data promotion server, a registered user whose registration time exceeds a preset time threshold in a user group followed by the merchant, or a registered user whose activeness exceeds a preset activeness threshold. In an example, the activeness may be measured by using a consumption frequency (such as the number of consumption times per month) of the registered user, a consumption amount of the registered user, or the like.

In an example, the data promotion server filters, according to the propagation rule in the marketing rule, the promotion user in step 603 from registered users managed by the data promote server. In an example, after a registered user consumes at a merchant, the data promotion server may select the registered user as the promotion user and provides the merchant coupon to the registered user.

In an example, there may be a plurality of promotion users filtered according to the propagation rule. In subsequent steps 604 to 608, by using one of the promotion users as an example, a coupon promotion process triggered by a particular promotion user is described in detail. It should be noted that a coupon promotion process triggered by another promotion user is similar to the process of steps 604 to 608. Details are not described herein again.

In step 604, the promotion user receives the merchant coupon by using a user client of the promotion user, and triggers the data promotion server to generate a personal coupon according to the merchant coupon and a user identifier of the promotion user.

In an example, reference may be made to steps 205 to 210 in FIG. 2 for a process of generating the personal coupon.

In step 605, the promotion user shares the personal coupon to other friends.

In an example, the other friends are people who establish a social relationship chain with the promotion user by using a social communications tool such as WeChat or microblog. In an example, when editing consumption experience, the promotion user adds the personal coupon to the consumption experience [SY3]for sharing to other friends. In an example, the consumption experience may be described by using pictures, text, and/or the like. In an example, the personal coupon may be presented by using a sharing format such as a one-dimensional code, a two-dimensional code, another graphic code, or a network link.

In step 606, the other friends receive the personal coupon, and consume at the merchant by using the personal coupon, to reduce a payment amount of consumption thereof.

In step 607, the data promotion server collects data application information of the personal coupon. In an example, the data application information includes: the number of use times of the personal coupon, a payment amount associated with the personal coupon, and the like.

In step 608, the data promotion server calculates a rebate amount of the promotion user according to the rebate rule in the marketing rule and the data application information of the personal coupon, and records the rebate amount into a personal account of the promotion user.

In an example, the data promotion server calculates the rebate amount according to the rebate rule configured by the merchant. In an example, the rebate rule is used to establish a mapping relationship between the data application information and the rebate amount. In an example, the rebate rule is: setting the rebate amount to 1% of the payment amount, rebating 1 Yuan each time the personal coupon is used, comprehensively determining the rebate amount according to the number of use times and the payment amount, or the like.

For example, a personal coupon 1 of a promotion user A is aimed at a merchant X, and a personal coupon 2 of a promotion user B is also aimed at the merchant X. The number of use times of the personal coupon 1 is 4, and the total payment amount is 660 Yuan. That is, the personal coupon 1 is used for 4 times, and the accumulated payment amount of the 4 use times is 660 Yuan. The number of use times of the personal coupon 2 is 3, and the payment amount is 560 Yuan. Assuming that the rebate rule is: the rebate amount=(1% of the payment amount+the number of use times), correspondingly, the rebate amount of the promotion user A is 10.5 Yuan, and the rebate amount of the promotion user B is 8.5 Yuan. By giving a particular rebate amount to the promotion user, the merchant may excite the promotion user to more promote and propagate the merchant information of the merchant by using the social relationship chain of the promotion user.

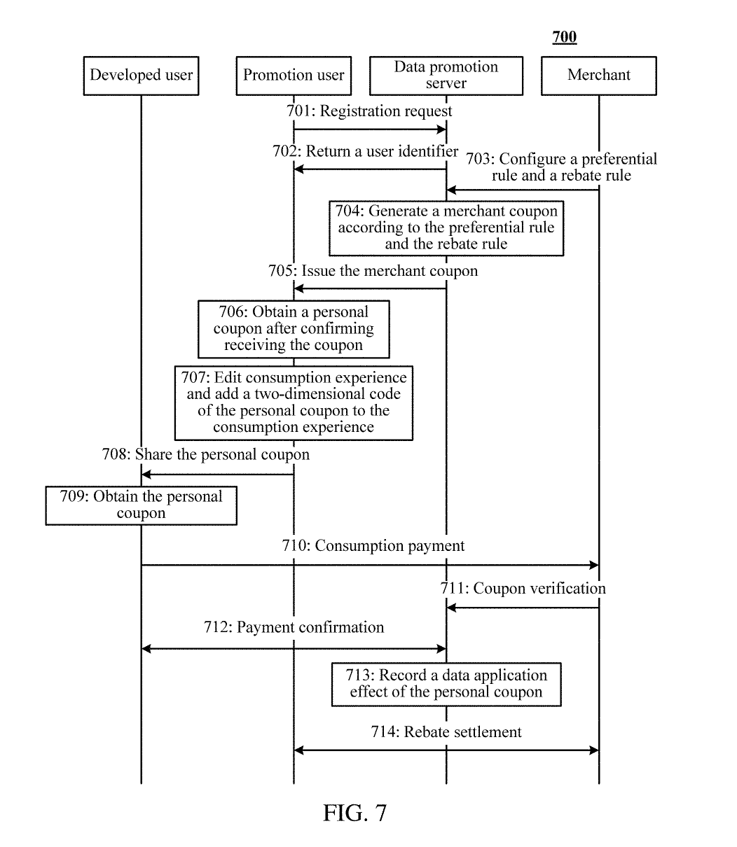

FIG. 7 is an interactive schematic diagram of a data processing method 700 according to an example embodiment of this application. In an example, the method 700 includes the following operations. It should be noted that user operations mentioned in the following descriptions are completed by a user client, and merchant operations mentioned in the following descriptions are completed by a merchant client.

In step 701, a network user makes a registration request to a data promotion server, to request to become a registered user of the data promotion server.

In step 702, the data promotion server returns a user identifier to the network user, that is, accepts the network user as a registered user of the data promotion server.

In step 703, a merchant configures a preferential rule on the data promotion server. Further, the merchant may further configure a series of marketing rules such as a rebate rule and a propagation rule.

In step 704, the data promotion server generates a merchant coupon according to the preferential rule. It should be noted that the data promotion server stores the merchant coupon generated by the data promotion server.

In step 705, the data promotion server delivers the merchant coupon to a promotion user. In an example, the promotion user is automatically selected by the data promotion system [SY4] from registered users of the data promotion system, or is selected according to the propagation rule configured by the merchant.

In step 706, the promotion user triggers the data promotion server to provide a personal coupon in a form of a two-dimensional code.

In an example, the data promotion server adds a user identifier of the promotion user to the merchant coupon, and generates the personal coupon for the promotion user. Specifically, after the promotion user receives the merchant coupon delivered by the data promotion server, a prompt box pops up on an interface of the user client. After the promotion user clicks OK, the user client sends a confirmation message to the data promotion server, and the data promotion server generates a personal coupon.

In an example, the promotion user may alternatively generate the personal coupon by himself/herself, and feeds back information items such as a data ID of the personal coupon and the user identifier of the promotion user to the data promotion server for storage. The promotion user also buffers the data ID of the personal coupon into a local (such as the user client used by the promotion user) coupon list.

In steps 707 and 708, when editing consumption experience after consuming at the merchant, the promotion user adds the personal coupon to the consumption experience, and issues same into a network for sharing.

In step 709, a developed user located in the network obtains the personal coupon.

It should be noted that the developed user is a potential customer, developed by the promotion user, of the merchant, and therefore is referred to as the developed user. The developed user may also forward the personal coupon for the second time by using a social relationship chain of the developed user. In an example, before forwarding the personal coupon, the developed user may also trigger the data promotion server to add a user identifier of the developed user to the personal coupon, to generate a dedicated coupon of the developed user.

In step 710, the developed user performs consumption payment by using the personal coupon.

In step 711, the merchant makes a coupon verification request to the data promotion server.

In step 712, after verification on the personal coupon succeeds, the data promotion server performs payment confirmation to the developed user, and deletes the personal coupon from a coupon list of the developed user. For the developed user, the personal coupon fails after use.

In step 713, the data promotion server records data application information of the personal coupon.

In step 714, according to a rebate rule configured by the merchant, the data promotion server calculates promotion feedback information (such as a rebate amount) of the promotion user, and records the promotion feedback information into a personal account of the promotion user.

In an example, when a coupon is used on the data promotion server, the data promotion server extracts one or more user identifiers carried in the coupon. For a coupon that has been forwarded for a plurality number of times, if a forwarding user adds a user identifier of the forwarding user to the coupon each time the coupon is forwarded, the coupon carries a plurality of user identifiers. Correspondingly, the data promotion server may record data application information for each user identifier carried in a same coupon, and generates a corresponding rebate amount. In an example, different rebate rules may be set for different levels of forwarding. For example, forwarding for the first time indicates a large rebate, and forwarding for the second time indicates a small rebate.

It should be noted that in the interaction process shown in FIG. 7, the operations of obtaining, by the promotion user, the merchant coupon, and generating the personal coupon for storage in steps 705 and 706, the operation of sharing, by the promotion user, the coupon in steps 707 and 708, and the operations of obtaining, by the developed user, the personal coupon and using the personal coupon in steps 709 and 710 are loosely associated. For example, the personal coupon is not necessarily propagated immediately after being generated in step 706. The promotion user selects an appropriate occasion to perform the sharing in step 708. For another example, after being shared in step 708, the personal coupon waits to be received and used by a developed user interested in the personal coupon.

According to this example embodiment of this application, a user identifier is carried in the personal coupon, and the foregoing loose association is extracted, so that the data promotion server may identify different functions implemented by different promotion users on promotion and propagation of the merchant information (presented in a form of the merchant coupon). Appropriate promotion feedback information is rewarded to the promotion user (for example, providing a rebate and the like matching the function implemented by the promotion user to the promotion user) to improve the frequency of propagating the merchant information in the network.

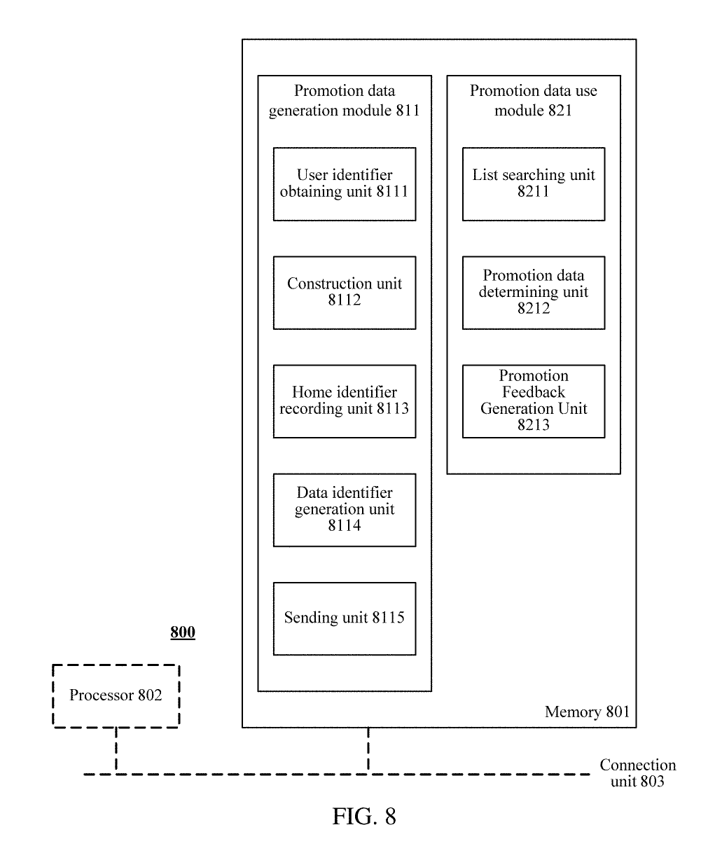

FIG. 8 is a schematic structural diagram of a data promotion server 800 according to an example embodiment of this application. In an example, the data promotion server 800 includes: a memory 801 and a processor 802. The processor 802 communicates with the memory 801 by using a connection unit 803, for executing program modules in the memory 801. In an example, constituent parts in the data promotion server 800 may communicate with each other by using the connection unit 803 such as a communications bus or a signal line.

In an example, the data promotion server 800 records a feedback rule set by a merchant client into first promotion data, and sends the first promotion data to promotion users corresponding to one or more user identifiers maintained by the data promotion server 800. Further, the data promotion server 800 may further receive a request for using second promotion data associated with the first promotion data, and verify the second promotion data. The second promotion data carries a home identifier indicating a promotion user to which the second promotion data belongs. After the verification succeeds, the data promotion server 800 extracts the home identifier from the second promotion data, collects data application information associated with the second promotion data, generates promotion feedback information according to the data application information, and records the promotion feedback information into a personal account corresponding to the home identifier. In an example, the data promotion server 800 may first record the data application information associated with the second promotion data into the personal account corresponding to the home identifier, then generate promotion feedback information at a specified time node, and record the promotion feedback into the personal account. As may be seen, the data promotion server 800 is responsible for operations such as generating the first promotion data, verifying use of the second promotion data, correcting a promotion effect (such as recording the data application information), and generating the promotion feedback information.

In an example, the memory 801 stores one or more programs, configured to be executed by one or more processors 802.

The one or more programs include the following instruction modules: a promotion data generation module 811 and a promotion data use module 821.

In an example, the promotion data generation module 811 generates the first promotion data with the feedback rule, and sends the first promotion data to a promotion user. Further, after receiving a confirmation message of the promotion user, the promotion data generation module 811 adds a user identifier of the promotion user as a home identifier to the first promotion data, to obtain second promotion data, and sends the second promotion data to the promotion user. In an example, the second promotion data has an information item: the home identifier, which does not exist in the first promotion data. In an example, the first promotion data is a merchant coupon. The second promotion data is a personal coupon associated with the merchant coupon. That is, a user identifier is added to the merchant coupon, and the merchant coupon becomes a personal coupon exclusive to a particular promotion user.

The feedback rule is used to indicate a correspondence between the promotion feedback information and the data application information. The data application information reflects a degree to which the second promotion data is applied. The promotion feedback information is the number of returned resources that is provided according to the feedback rule based on the data application information of the second promotion data.

In an example, when receiving a resource transfer request for a developed user, the promotion data use module 821 searches for third promotion data available to the developed user, and reduces the number of transferred resources of the developed user according to the third promotion data. In an example, the promotion data use module 821 deducts, from the number of transferred resources, the number of returned resources that is indicated in the third promotion data. Further, the promotion data use module 821 extracts the home identifier and the feedback rule from the third promotion data, and determines the promotion feedback information for the promotion user corresponding to the home identifier according to the feedback rule and data application information of the third promotion data.

In an example, the promotion data generation module 811 includes: a user identifier obtaining unit 8111, a construction unit 8112, a home identifier recording unit 8113, a data identifier generation unit 8114, and a sending unit 8115.

The user identifier obtaining unit 8111 obtains the user identifier of the promotion user from the confirmation message. The construction unit 8112 constructs a promotion data record as the second promotion data, and records one or more information items of the first promotion data into the promotion data record. The home identifier recording unit 8113 adds an information item: the home identifier to the promotion data record, for recording the user identifier of the promotion user. The data identifier generation unit 8114 generates a first data identifier for the promotion data record, for identifying the second promotion data. The sending unit 8115 sends the first data identifier to the promotion user.

In an example, the construction unit 8112 further generates the first promotion data with one or more information items. The information items include: a second data identifier, an issue identifier, a preferential rule, and the feedback rule. The second data identifier is used to identify the first promotion data. The issuing identifier is used to indicate a merchant issuing the first promotion data. The preferential rule is used to indicate the number of returned resources, or the number of transferred resources that may be reduced in resource transfer.

In an example, the promotion data use module 821 includes: a list searching unit 8211 and a promotion data determining unit 8212.

The list searching unit 8211 finds an available data list of the developed user according to a user identifier carried in the resource transfer request. The promotion data determining unit 8212 finds, in one or more promotion data records corresponding to the available data list, a promotion data record in which an issuing identifier matches a merchant identifier carried in the resource transfer request, as the third promotion data. That is, the data promotion server 800 searches whether the developed user has a coupon of a corresponding merchant, so as to determine whether to provide payment preference discount to the developed user.

In an example, the promotion data use module 821 further includes: a promotion feedback generation unit 8213, configured to: record data application information of the third promotion data, convert the data application information into rebate information according to a correspondence recorded in the feedback rule, and record the rebate information into a personal account of a promotion user corresponding to the home identifier. The data application information includes: the number of transferred resources associated with the third promotion data, and/or, a corresponding number of use times of the home identifier in the third promotion data.

It should be noted that reference may be made to detailed descriptions in FIG. 1 to FIG. 7 for specific operations of the data promotion server 800.

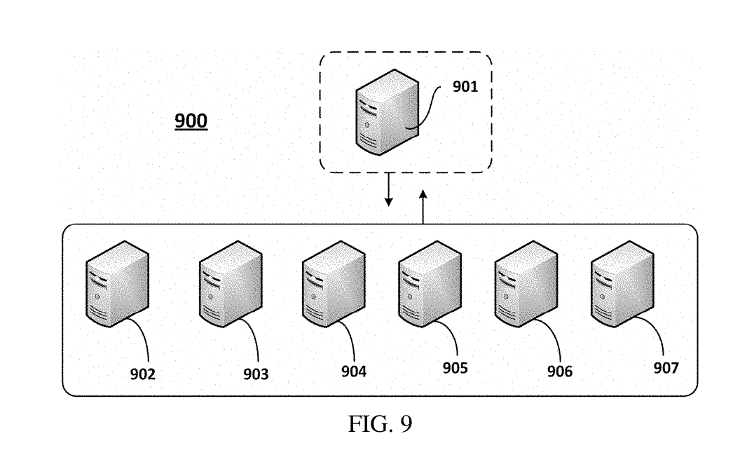

FIG. 9 is a schematic structural diagram of a WeChat server 900 according to an example embodiment of this application. In an example, the WeChat server 900 includes: an access server 901, a registration and login logic 902, a message transceiving logic 903, a friend circle logic 904, a payment logic 905, a coupon promotion logic 906, another logic 907, and the like.

In an example, the access server 901 functions as an interface in the WeChat server 900. Requests of all network users are all first sent to the access server 901, and then the access server 901 distributes, according to the function and the state of each logic server (logicsvr) in the WeChat server 900, the network requests to a logic server for actual processing.

In an example, the registration and login logic 902 is used to manage a registration request of a network user, a login operation of a registered user, and the like. The registration and login logic 902 may further set a user database for storing information such as a personal account of a registered user.

In an example, the message transceiving logic 903 is used for sending and receiving WeChat messages (including private chat messages, group chat messages, and the like). In an example, the message transceiving logic 903 may be disassembled into 3 service modules: message synchronization, text and voice message transmission, and picture and video message transmission. In an example, the friend circle logic 904 is used for supporting operations of a registered user such as posting text and pictures, sharing articles or music, and making comments on content issued by WeChat friends of the registered user in the circle of friends by using the circle of friends. In an example, the payment logic 905 is used for implementing a payment function of a WeChat client.

In an example, the coupon promotion logic 906 is used for implementing a function of the data promotion server of FIG. 1 to FIG. 8. In an example, the another logic may include: a location based service (LBS) logic, a shake logic, a current bottle logic, and the like. In specific implementation, each logic server shown in FIG. 9 may be deployed on one or more physical servers.

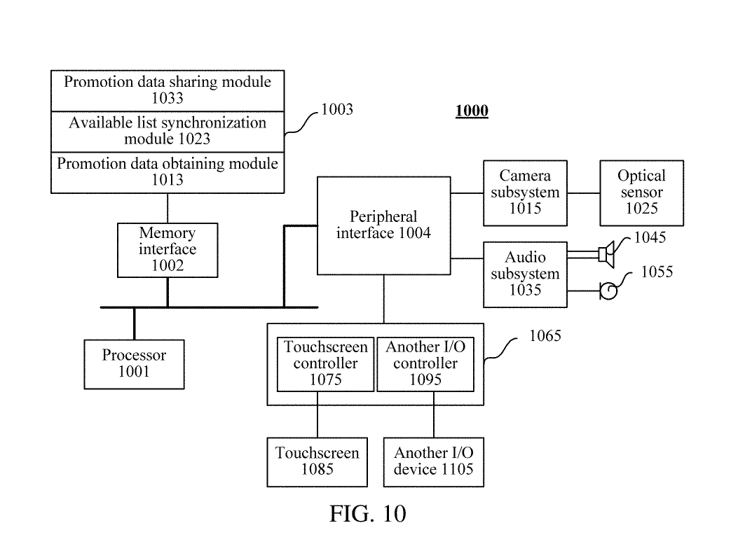

FIG. 10 is a schematic structural diagram of a user terminal 1000 according to an example embodiment of this application. In an example, the user terminal 1000 includes: a processor 1001, a memory interface 1002, and a memory 1003 connected to the memory interface 1002.

In an example, the memory 1003 includes: a random access memory (RAM), a non-volatile memory, and/or the like. In an example, the non-volatile memory may be a magnetic disk storage apparatus, an optical storage apparatus, a flash memory (such as a NAND or a NOR), and/or the like.

In an example, the memory 1003 stores one or more programs, configured to be executed by one or more processors 1001.

The one or more programs include the following instruction modules: a promotion data obtaining module 1013 and an available list synchronization module 1023.

After receiving first promotion data, the promotion data obtaining module 1013 replies a confirmation message to the data promotion server, the confirmation message including a user identifier of the user terminal, and triggers the data promotion server to generate second promotion data associated with the first promotion data. Further, the promotion data obtaining module 1013 receives the second promotion data, and stores the second promotion data into a first available data list of the user terminal 1000. The first available data list is stored in the user terminal. The second promotion data carries the user identifier of the user terminal as a home identifier. The home identifier is used for determining the user terminal 1000 propagating the second promotion data.

In an example, the available list synchronization module 1023 sends an available list update request to the data promotion server, the available list update request including the user identifier of the user terminal 1000 and a data identifier of the second promotion data; and triggers the data promotion server to update a second available data list of the user terminal 1000, the second available data list being stored in the data promotion server.

In an example, the program module 1003 further includes: a promotion data sharing module 1033, configured to: send a data sharing request to the data promotion server, the data sharing request including the user identifier of the user terminal 1000; receive candidate promotion data whose data attribute is spread from the data promotion server, and select actual promotion data from the candidate promotion data; send a data identifier of the actual promotion data to the data promotion server, and receive a sharing format of the actual promotion data; and issue the sharing format by using a social relationship chain of the user terminal 1000.

In an example, the user terminal 1000 is a user client (such as a software application). Reference may be made to detailed descriptions for the user client in FIG. 1 to FIG. 7 for specific operations of the user terminal 1000. In an example, the user terminal 1000 is a hardware device, and further includes: a peripheral interface 1004, configured to connect to a sensor, various apparatuses and subsystems, and the like, so as to support function expansion of the user terminal 1000. In an example, the peripheral interface 1004 may be connected to camera subsystem 1015 and an optical sensor 1025, for implementing a camera function, such as capturing a photo or recording a video. In an example, the peripheral interface 1004 may be connected to an audio subsystem 1035, a speaker 1045, a loudspeaker 1055, and the like, for implementing voice related functions, such as speech recognition, recording, and making a call. In an example, the peripheral interface 1004 may be connected to an I/O subsystem 1065, for supporting various input and output devices. In an example, the I/O subsystem 1065 includes a touchscreen controller 1075, configured to connect to a touchscreen 1085. The touchscreen controller 1075 and the touchscreen 1085 detect touch conditions, contact movement, touch stop, and the like based on touch sensitive technologies. In an example, the touch sensitive technologies include technologies such as capacitor technologies, resistance technologies, infrared technologies, and surface acoustic wave technologies. The I/O subsystem 1065 further includes another I/O controller 1095, configured to connect to another I/O device 1105. In an example, the another I/O device 1105 includes an infrared interface, a USB interface, and the like.

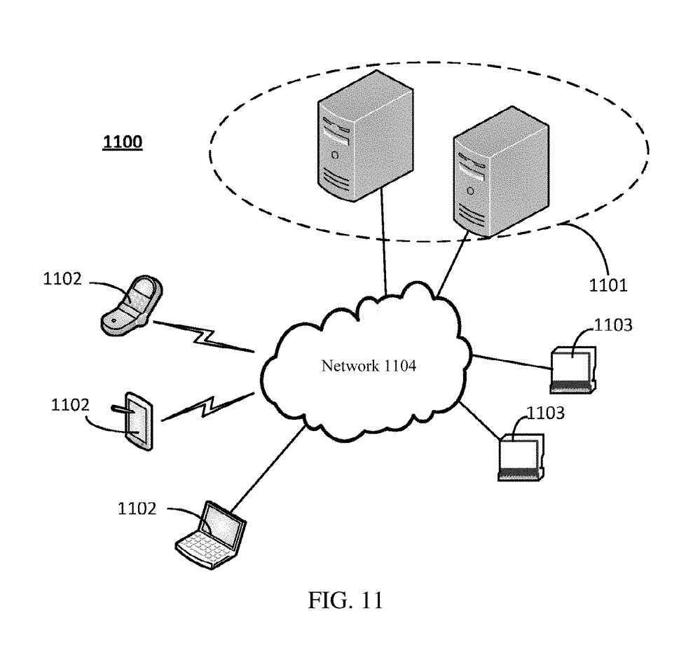

FIG. 11 is a schematic diagram of composition of a communications system 1100 according to an example embodiment of this application. In an example, the communications system 1100 includes: a data promotion server 1101, one or more user clients 1102, one or more merchant clients 1103, and a network 1104.

In an example, the data promotion server 1101 is configured to implement the functions of FIG. 8 and FIG. 9. The user client 1102 is configured to implement the function of the user terminal 1000 in FIG. 10. The merchant client 1103 is configured to configure a preferential rule, a feedback rule, and the like. In an example, the network 1104 may be formed by communications networks of different types such as a backbone network, a metropolitan area network, a GSM network, a GPRS network, a 3G network, a 4G network, a 5G network, Wi-Fi, and Bluetooth. It should be noted that reference may be made to detailed descriptions in FIG. 6 and FIG. 7 for specific operations of the communications system 1100.

A person of ordinary skill in the art may understand that all or some of the processes of the methods in the foregoing examples may be implemented by a computer program instructing relevant hardware. The program may be stored in a computer readable storage medium. The storage medium may be a magnetic disk, an optical disc, a read-only memory (ROM), a RAM, or the like.

Therefore, this application further provides a storage medium storing a data processing program. The data processing program is used for executing any example embodiment of the foregoing method of this application.

The foregoing descriptions are merely example embodiments of this application, and are not intended to limit this application. Any modification, equivalent replacement, improvement and the like made within the spirit and principle of this application should fall within the protection scope of this application and the appended claims.

1-18. (canceled)

19. A method comprising:
generating first promotion data including a feedback rule that indicates a correspondence between promotion feedback information and data application information, and sending the first promotion data to a first user;
in response to receiving a confirmation message from the first user, adding a user identifier of the first user, as a home identifier, to the first promotion data, to obtain second promotion data, and sending the second promotion data to the first user;
in response to receiving a resource transfer request from a second user, searching for third promotion data that comprises the home identifier and the feedback rule and that is available to the second user, and reducing a number of transferred resources of the second user according to the third promotion data; and
extracting the home identifier and the feedback rule from the third promotion data, and determining the promotion feedback information for the first user corresponding to the home identifier according to the feedback rule and data application information of the third promotion data.

20. The method according to claim 19, wherein the adding and sending comprises:
obtaining the user identifier of the first user from the confirmation message;
constructing a promotion data record as the second promotion data, and recording one or more information items of the first promotion data into the promotion data record;
adding an information item of the one or more information items as the home identifier to the promotion data record, for recording the user identifier of the first user;
generating a first data identifier for the promotion data record, for identifying the second promotion data; and
sending the first data identifier to the first user.

21. The method according to claim 19, wherein the generating the first promotion data comprises generating the first promotion data including one or more of a second data identifier, an issuing identifier, and a preferential rule,
wherein the second data identifier identifies the first promotion data, the issuing identifier indicates a merchant issuing the first promotion data, and the preferential rule indicates the number of transferred resources to be reduced in resource transfer.

22. The method according to claim 19, wherein the searching for third promotion data comprises:
generating an available data list of the second user according to a user identifier included in the resource transfer request; and
finding, in one or more promotion data records corresponding to the available data list, a promotion data record in which an issuing identifier matches a merchant identifier included in the resource transfer request, and determining the found promotion data record as the third promotion data.

23. The method according to claim 19, wherein the determining the promotion feedback information comprises:
recording the data application information of the third promotion data; and
converting the data application information into rebate information according to the correspondence recorded in the feedback rule, and recording the rebate information into a personal account of the first user corresponding to the home identifier,
wherein the data application information comprises the number of transferred resources associated with the third promotion data, and/or, a corresponding number of use times of the home identifier in the third promotion data.

24. The method according to claim 19, further comprising:
receiving, from the first user, an available list update request including a user identifier;
finding an available data list according to the user identifier; and
recording a data identifier included in the available list update request into the available data list.

25. The method according to claim 19, further comprising:
receiving, from the first user, a data sharing request including the user identifier;
finding, in one or more promotion data records corresponding to the available data list, candidate promotion data whose data attribute is spread, and providing the candidate promotion data to the first user;
receiving actual promotion data selected by the first user, generating a sharing format corresponding to the actual promotion data selected by the first user, and providing the sharing format to the first user.

26. The method according to claim 25, wherein the sharing format is in a form of a one-dimensional code, a two-dimensional code, or a graphic code, or in a form of a network link.

27. The method according to claim 26, wherein the sharing format is in the form of the network link; and
in response to the network link being clicked, a data identifier of the actual promotion data is stored into an available data list of a user client that clicked the network link.

28. A server comprising:
at least one memory configured to store computer program code; and
at least one processor configured to access the at least one memory and operate according to the computer program code, the computer program code including:
promotion data generation code configured to cause the at least one processor to:
generate first promotion data including a feedback rule that indicates a correspondence between promotion feedback information and data application information, and send the first promotion data to a first user;
in response to receiving a confirmation message from the first user, add a user identifier of the first user, as a home identifier, to the first promotion data, to obtain second promotion data, and send the second promotion data to the first user; and
promotion data use code configured to cause the at least one processor to:
in response to receiving a resource transfer request from a second user, search for third promotion data that comprises the home identifier and the feedback rule and that is available to the second user, and reduce a number of transferred resources of the second user according to the third promotion data; and
extract the home identifier and the feedback rule from the third promotion data, and determine the promotion feedback information for the first user corresponding to the home identifier according to the feedback rule and data application information of the third promotion data.

29. The server according to claim 28, wherein the promotion data generation code comprises:
user identifier obtaining code configured to cause the at least one processor to obtain the user identifier of the first user from the confirmation message;
construction code configured to cause the at least one processor to construct a promotion data record as the second promotion data, and record one or more information items of the first promotion data into the promotion data record;
home identifier recording code configured to cause the at least one processor to add an information item of the one or more information items as the home identifier to the promotion data record, for recording the user identifier of the first user;
data identifier generation code configured to cause the at least one processor to generate a first data identifier for the promotion data record, for identifying the second promotion data; and
sending code configured to cause the at least one processor to send the first data identifier to the first user.

30. The server according to claim 28, wherein the construction code is further configured to:
generate the first promotion data including one or more of a second data identifier, an issuing identifier, and a preferential rule,
wherein the second data identifier identifies the first promotion data, the issuing identifier indicates a merchant issuing the first promotion data, and the preferential rule indicates the number of transferred resources to be reduced in resource transfer.

31. The server according to claim 28, wherein the promotion data use code comprises:
list searching code configured to cause the at least one processor to generate an available data list of the second user according to a user identifier included in the resource transfer request; and
promotion data determining code configured to cause the at least one processor to find, in one or more promotion data records corresponding to the available data list, a promotion data record in which an issuing identifier matches a merchant identifier included in the resource transfer request, and determine the found promotion data record as the third promotion data.

32. The server according to claim 28, wherein the promotion data use code further comprises promotion feedback generation code configured to cause the at least one processor to: record the data application information of the third promotion data; and
convert the data application information into rebate information according to the correspondence recorded in the feedback rule, and record the rebate information into a personal account of the first user corresponding to the home identifier,
wherein the data application information comprises the number of transferred resources associated with the third promotion data, and/or, a corresponding number of use times of the home identifier in the third promotion data.

33. A non-transitory computer readable storage medium, storing a program which, when executed by a computer, perform the operations:
generating first promotion data including a feedback rule that indicates a correspondence between promotion feedback information and data application information, and sending the first promotion data to a first user;
in response to receiving a confirmation message from the first user, adding a user identifier of the first user, as a home identifier, to the first promotion data, to obtain second promotion data, and sending the second promotion data to the first user;
in response to receiving a resource transfer request from a second user, searching for third promotion data that comprises the home identifier and the feedback rule and that is available to the second user, and reducing a number of transferred resources of the second user according to the third promotion data; and
extracting the home identifier and the feedback rule from the third promotion data, and determining the promotion feedback information for the first user corresponding to the home identifier according to the feedback rule and data application information of the third promotion data.
